(19) United States
(12) Patent Application Publication
(10) Pub. No.: US 2013/0063522 A1
(43) Pub. Date: Mar. 14, 2013

(54) INKJET HEAD AND INKJET RECORDING APPARATUS

(71) Applicants: Ryuichi Arai, Numazu-shi (JP); Chiaki Tanuma, Tokyo (JP); Ryutaro Kusunoki, Mishima-shi (JP); Shuhei Yokoyama, Mishima-shi (JP)

(72) Inventors: Ryuichi Arai, Numazu-shi (JP); Chiaki Tanuma, Tokyo (JP); Ryutaro Kusunoki, Mishima-shi (JP); Shuhei Yokoyama, Mishima-shi (JP)

(73) Assignee: TOSHIBA TEC KABUSHIKI KAISHA, Tokyo (JP)

(21) Appl. No.: 13/600,477

(22) Filed: Aug. 31, 2012

(30) Foreign Application Priority Data
Sep. 13, 2011 (JP) 2011-199922
Jul. 20, 2012 (JP) 2012-161718

(51) Int. Cl. B41J 2/145

(52) U.S. Cl. 347/40

(57) ABSTRACT

According to one embodiment, an inkjet head includes nozzle rows. Each of the nozzle rows includes nozzles. The nozzles are arranged at a fixed pitch in a direction orthogonal to a conveying direction of a recording medium and arranged spaced apart from one another in the conveying direction in each of the nozzle rows. At least one nozzle located at one end of each of the nozzle rows is provided on an upstream side along the conveying direction than another nozzle provided closest to the nozzle in an arraying direction of the nozzles. At least one nozzle located at the other end of each of the nozzle rows is provided on a downstream side along the conveying direction than another nozzle provided closest to the nozzle in the arraying direction of the nozzles.

### CROSS-REFERENCE TO RELATED APPLICATIONS

This application is based upon and claims the benefit of priority from Japanese Patent Applications No. 2011-199922, filed on Sep. 13, 2011; and No. 2012-161718, filed on Jul. 20, 2012, the entire contents of all of which are incorporated herein by reference.

### FIELD

Embodiments described herein relate generally to an inkjet head that ejects ink from plural nozzles to a recording medium and an inkjet recording apparatus including the inkjet head.

### BACKGROUND

An inkjet head includes plural nozzles for ejecting ink to a recording medium such as recording paper. The ink ejected from the nozzles forms an image on the recording medium conveyed in a fixed direction.

There is known an inkjet head in which plural nozzle rows, each of which includes plural nozzles, are arrayed in the width direction of a recording medium in order to improve the resolution of an image formed on the recording medium. In the inkjet head of this type, all the nozzles are arranged at a fixed pitch in the width direction of the recording medium. At the same time, the nozzles included in the nozzle rows are regularly arrayed spaced apart from one another in an oblique direction having a fixed angle with respect to a conveying direction of the recording medium.

In the inkjet head in the related art in which the plural nozzles are regularly arrayed, a nozzle located at the terminal end of one nozzle row and a nozzle located at the starting end of another nozzle row adjacent to the nozzle row are apart from each other in the conveying direction of the recording medium by a distance equivalent to the length of the nozzle row.

With this configuration, if the recording medium is conveyed to the inkjet head in proper posture without tilting in the direction in which the nozzle rows extend, it is possible to obtain an image having desired resolution using the ink ejected from the nozzles.

However, if the recording medium is conveyed while tilting in the direction in which the nozzle rows extend, it is inevitable that a pitch of the nozzles widens between the ends of the adjacent nozzle rows. Therefore, an interval of dots of the ink arriving on the recording medium sometimes widens to cause white streak-like printing unevenness in a place corresponding to a space between the adjacent nozzle rows on the recording medium.

If a white streak remains on an image, the streak tends to attract notice and prevents a high-quality image from being obtained.

### BRIEF DESCRIPTION OF THE DRAWINGS

FIG. 1 is an exemplary schematic side view of an inkjet recording apparatus according to a first embodiment;

FIG. 2 is an exemplary plan view of an inkjet head according to the first embodiment;

FIG. 3 is an exemplary plan view of the inkjet head in a state in which plural nozzle rows are arranged on a nozzle surface of a nozzle plate in the first embodiment;

FIG. 4 is an exemplary sectional view taken along line F4-F4 shown in FIG. 3;

FIG. 5 is an exemplary sectional view taken along line F5-F5 shown in FIG. 4;

FIG. 6 is an exemplary plan view of the inkjet head in which a pitch among plural nozzles included in the nozzle row is shown in exaggeration in the first embodiment;

FIG. 7 is an exemplary sectional view of a state in which, in the first embodiment, a vibrating plate is laminated on a base included in a protective layer;

FIG. 8 is an exemplary sectional view of a state in which, in the first embodiment, a thin film, which is the base of a first electrode, is formed on the vibrating plate;

FIG. 9 is an exemplary sectional view of a state in which, in the first embodiment, the first electrode is formed on the vibrating plate;

FIG. 10 is an exemplary sectional view of a state in which, in the first embodiment, the vibrating plate and the first electrode are covered with a piezoelectric film;

FIG. 11 is an exemplary sectional view of a state in which, in the first embodiment, a piezoelectric layer is formed on the first electrode;

FIG. 12 is an exemplary sectional view of a state in which, in the first embodiment, a thin film, which is the base of a second electrode, is formed on the piezoelectric layer;

FIG. 13 is an exemplary sectional view of a state in which, in the first embodiment, the second electrode is formed on the piezoelectric layer;

FIG. 14 is an exemplary sectional view of a state in which, in the first embodiment, an electrode protecting film is laminated on the second electrode and the vibrating plate;

FIG. 15 is an exemplary sectional view of a state in which, in the first embodiment, a first substrate is laminated on the vibrating plate and an ink pressure chamber is formed in the first substrate;

FIG. 16 is an exemplary sectional view of a state in which, in the first embodiment, the electrode protecting film is removed from the vibrating plate on which the first substrate is laminated;

FIG. 17 is an exemplary sectional view of a state in which, in the first embodiment, a protective layer is laminated on the second electrode and the vibrating plate;

FIG. 18 is an exemplary sectional view of a state in which, in the first embodiment, a liquid repellent film is formed on the protective layer and nozzles are formed in the protective layer and the liquid repellent film;

FIG. 19 is an exemplary sectional view of a state in which, in the first embodiment, a nozzle protecting film is formed on the liquid repellent film;

FIG. 20 is an exemplary sectional view of a state in which, in the first embodiment, a second substrate including an ink circulation chamber is bonded on the first substrate;

FIG. 21 is an exemplary sectional view of a state in which, in the first embodiment, the nozzle protecting film is peeled to expose the nozzles;

FIG. 22 is an exemplary plan view of an inkjet head in a comparative example in which plural nozzles are linearly arranged;

FIG. 23 is an exemplary plan view of an inkjet head according to a second embodiment;

FIG. 24 is an exemplary sectional view of an inkjet head according to a third embodiment; and

FIG. 25 is an exemplary sectional view of an inkjet head according to a fourth embodiment.

### DETAILED DESCRIPTION

In general, according to one embodiment, an inkjet head includes a nozzle plate and a plurality of nozzle rows provided on the nozzle plate to be arranged in a direction orthogonal to a conveying direction of a recording medium. Each of the nozzle rows includes a plurality of nozzles for ejecting ink to the recording medium. The nozzles are arranged at a fixed pitch along a direction orthogonal to the conveying direction of the recording medium and arranged spaced apart from one another in the conveying direction of the recording medium in each of the nozzle rows. At least one nozzle located at one end of each of the nozzle rows is provided further on an upstream side along the conveying direction of the recording medium than another nozzle provided closest to the nozzle in an arraying direction of the nozzles arranged at the fixed pitch. At least one nozzle located at the other end of each of the nozzle rows is provided further on a downstream side along the conveying direction of the recording medium than another nozzle provided closest to the nozzle in the arraying direction of the nozzles arranged at the fixed pitch.

### First Embodiment

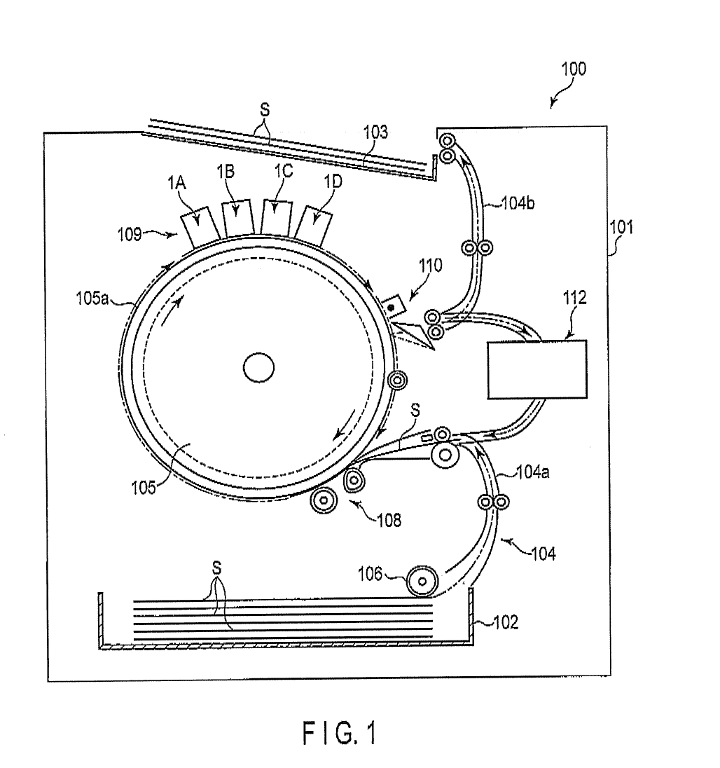

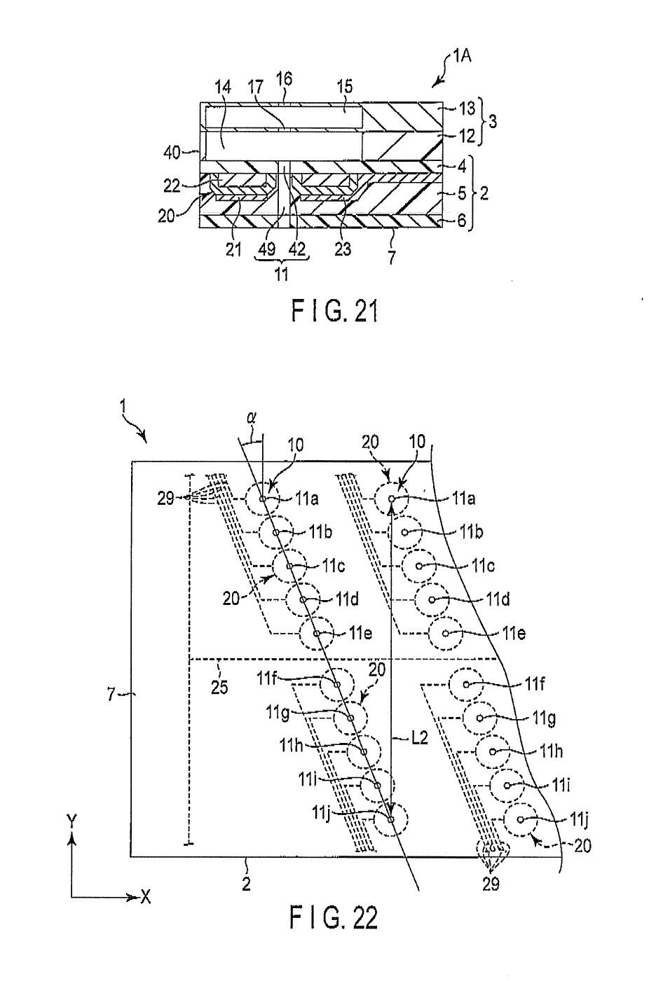

A first embodiment is explained with reference to FIGS. 1 to 22.

FIG. 1 is a schematic diagram of an example of an inkjet recording apparatus 100. The inkjet recording apparatus 100 includes a box-like housing 101 that forms the outer hull of the inkjet recording apparatus 100. As shown in FIG. 1, a paper feeding cassette 102, a paper discharge tray 103, a conveying path 104, and a holding drum 105 are housed on the inside of the housing 101.

The paper feeding cassette 102 is a component that stores sheets S, which are an example of recording media. The paper feeding cassette 102 is arranged in the bottom of the housing 101. As the sheets S, for example, plain sheets, art paper, OHP sheets, and the like can be used. The paper discharge tray 103 is provided in an upper part of the housing 101 and exposed to the outside of the housing 101.

The conveying path 104 includes an upstream section 104a continuous to the paper feeding cassette 102 and a downstream section 104b continuous to the paper discharge tray 103. The sheets S stored in the paper feeding cassette 102 are delivered to the upstream section 104a of the conveying path 104 by a roller 106 one by one.

The holding drum 105 is arranged between the paper feeding cassette 102 and the paper discharge tray 103. The sheet S delivered from the paper feeding cassette 102 to the upstream section 104a of the conveying path 104 is led to the downstream section 104b of the conveying path 104 through an outer circumferential surface 105a of the holding drum 105. Specifically, the holding drum 105 is configured to rotate at constant speed in the circumferential direction in a state in which the holding drum 105 holds the sheet S on the circumferential surface 105a.

As shown in FIG. 1, a sheet pressing device 108, an image forming device 109, a charge removing device 110, and a cleaning device 111 are arranged around the holding drum 105. The sheet pressing device 108, the image forming device 109, the charge removing device 110, and the cleaning device 111 are arranged in order from upstream to downstream along the rotating direction of the holding drum 105.

The sheet pressing device 108 presses the sheet S, which is supplied from the upstream section 104a of the conveying path 104 to the outer circumferential surface 105a of the holding drum 105, against the outer circumferential surface 105a of the holding drum 105. The sheet S pressed against the outer circumferential surface 105a of the holding drum 105 is attracted to the outer circumferential surface 105a of the holding drum 105 by an electrostatic force.

The image forming device 109 is a component for forming an image on the sheet S attracted to the outer circumferential surface 105a of the holding drum 105. The image forming device 109 in this embodiment includes, for example, a first inkjet head 1A that forms a cyan image, a second inkjet head 1B that forms a magenta image, a third inkjet head 1C that forms an yellow image, and a fourth inkjet head 1D that forms a black image. The first to fourth inkjet heads 1A, 1B, 1C, and 1D are arrayed spaced apart from one another in the rotating direction of the holding drum 105. The rotating direction of the holding drum 105 can be rephrased as a conveying direction of the sheet S conveyed along the outer circumferential surface 105a of the holding drum 105.

The charge removing device 110 has a function of removing charges of the sheet S on which a desired image is formed and peeling the sheet S off the outer circumferential surface 105a of the holding drum 105 after the charge removal. The sheet S peeled off the outer circumferential surface 105a of the holding drum 105 is led to the paper discharge tray 103 through the downstream section 104b of the conveying path 104.

The cleaning device 111 has a function of cleaning the outer circumferential surface 105a of the holding drum 105 from which the sheet S is peeled. Further on the downstream side along the rotating direction of the holding drum 105 than the charge removing device 110, the cleaning device 111 is movable between a position where the cleaning device 111 is in contact with the outer circumferential surface 105a of the holding drum 105 and a position where the cleaning device 111 is separated from the outer circumferential surface 105a of the holding drum 105.

Further, the inkjet recording apparatus 100 according to this embodiment includes a reversing device 112 that reverses the front and the back of the sheet S. The reversing device 112 reverses the sheet S, which is peeled off the outer circumferential surface 105a of the holding drum 105 by the charge removing device 110, and returns the sheet S to the upstream section 104a of the conveying path 104. consequently, the sheet S is supplied to the outer circumferential surface 105a of the holding drum 105 again in a state in which the front and the back of the sheet S are reversed. Therefore, it is possible to form desired images on both the front and rear surfaces of the sheet S.

The first to fourth inkjet heads 1A, 1B, 1C, and 1D included in the image forming device 109 basically include a common configuration. Therefore, in this embodiment, the configuration of the first inkjet head 1A is representatively explained.

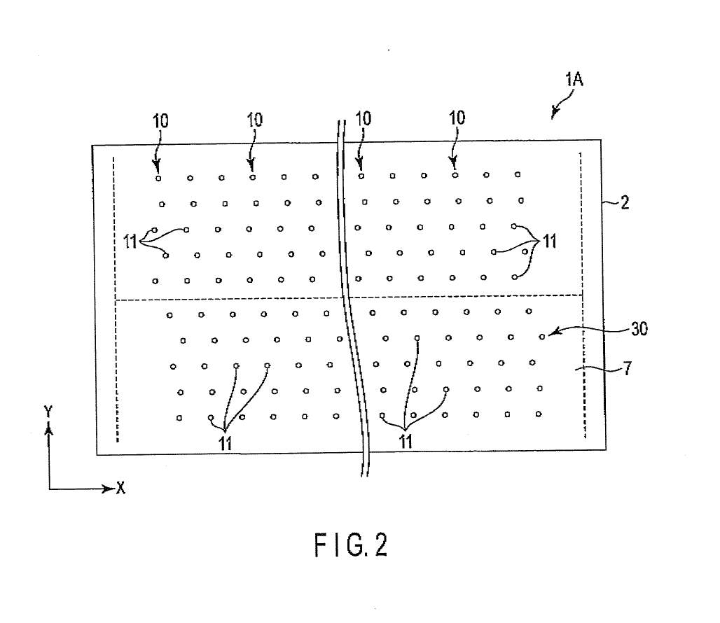

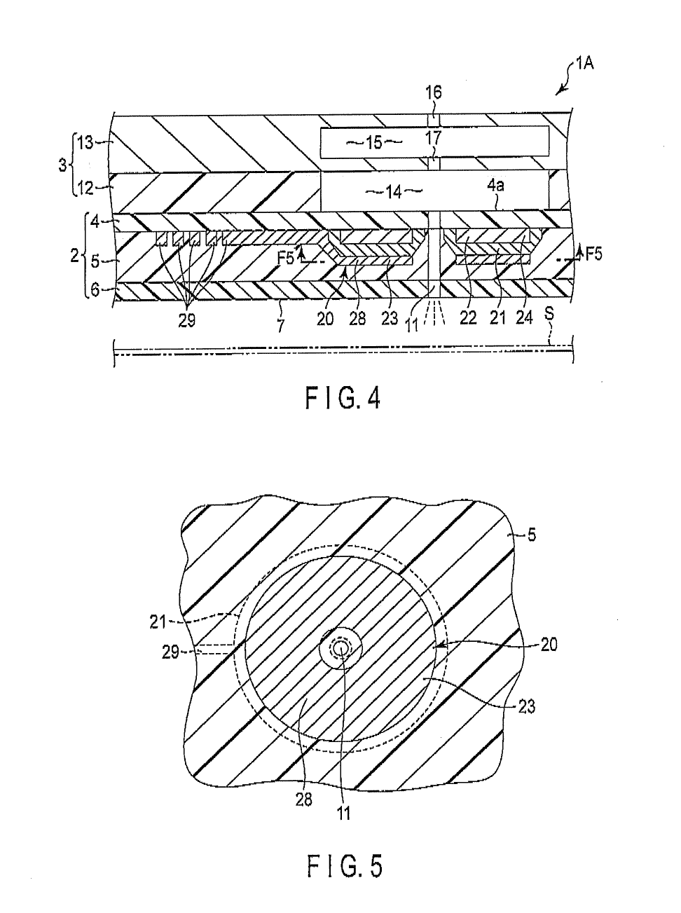

As shown in FIGS. 2 to 4, the first inkjet head 1A has an elongated shape extending in the direction orthogonal to the conveying direction of the sheet S. As shown in FIG. 4, the first inkjet head 1A includes a nozzle plate 2 and a head main body 3. The nozzle plate 2 has a three-layer structure including a vibrating plate 4, a protective layer 5, and a liquid repellent film 6.

The vibrating plate 4 is formed of, for example, a silicon oxide film having electric insulation properties. The thickness of the vibrating plate 4 is about equal to or smaller than 10 μm. In the first embodiment, the silicon oxide film is formed by thermal oxidation with substrate temperature set to about 1000° C. As a manufacturing method for the silicon oxide film, a CVD (chemical vapor deposition) or an RF magnetron sputtering method can be used.

The protective layer 5 is laminated on the vibrating plate 4. The protective layer 5 is formed of a resin material such as polyimide. The thickness of the protective layer 5 is 6 μm. In the first embodiment, the protective layer 5 is formed by, for example, spin coating. As the material of the protective layer 5, for example, a resin material such as polyurea or an oxide film of SiO₂ or the like can also be used. In this case, the thickness of the protective layer 5 is about 3 μm to 20 μm.

The liquid repellent film 6 is laminated on the protective layer 5. The liquid repellent film 6 is formed of, for example, a material having a characteristic for repelling ink such as fluorocarbon resin. In the first embodiment, the liquid repellent film 6 is formed by, for example, the spin coating. The thickness of the liquid repellent film 6 is about 0.1 μm to 5 μm and preferably 1 μm. The liquid repellent film 6 forms a nozzle surface 7, which is the surface of the nozzle plate 2. The nozzle surface 7 is exposed to the outside of the first inkjet head 1A to face a surface to be printed of the sheet S.

As shown in FIG. 2, plural nozzle rows 10 are formed on the nozzle plate 2. The nozzle rows 10 are arranged in a row spaced apart from one another in the longitudinal direction of the first inkjet head 1A indicated by an arrow X. The longitudinal direction of the first inkjet head 1A means the direction orthogonal to the conveying direction of the sheet S indicated by the arrow Y. The longitudinal direction of the first inkjet head 1A coincides with the width direction of the sheet S.

Each of the nozzle rows 10 includes plural nozzles 11. The nozzles 11 are holes that pierce through the nozzle plate 2 in the thickness direction. The diameter of the nozzles 11 is, for example, 20 μm. The nozzles 11 are opened in the nozzle surface 7 of the nozzle plate 2 and a surface 4a of the vibrating plate 4 located on the opposite side of the nozzle surface 7.

The head main body 3 includes a first substrate 12 and a second substrate 13. The first substrate 12 is formed of, for example, a single silicon substrate. The thickness of the first substrate 12 is, for example, 675 μm. The first substrate 12 is laminated on the surface 4a of the vibrating plate 4 and integrated with the vibrating plate 4.

Ink pressure chambers 14 are formed in the first substrate 12 in the same number as the nozzles 11. The ink pressure chambers 14 are formed in, for example, a cylindrical shape having a diameter of 250 μm. One opening ends of the nozzle pressure chambers 14 are closed by the vibrating plate 4.

In other words, the vibrating plate 4 is exposed to the ink pressure chambers 14. The ink pressure chambers 14 are provided to correspond to the nozzles 11. The nozzles 11 are provided to respectively communicate with the centers of the ink pressure chambers 14.

The second substrate 13 is made of a metal material such as stainless steel. The thickness of the second substrate 13 is, for example, 4 mm. The second substrate 13 is laminated on the first substrate 12 and fixed to the first substrate 12 using, for example, an epoxy adhesive.

Plural ink circulation chambers 15 are formed on the inside of the second substrate 13. The ink circulation chambers 15 are formed in, for example, a cylindrical shape that is 2 mm deep along the thickness direction of the second substrate 13. Ink for image formation is supplied from the outside of the first inkjet head 1A to the ink circulation chambers 15 through ink supply ports 16.

The ink circulation chambers 15 communicate with the ink pressure chambers 14 through communicating ports 17. The communicating ports 17 are holes having a diameter smaller than the nozzle 11. The communicating ports 17 are formed in the second substrate 13 to be coaxial with the nozzles 11. The ink distributed from the ink supply ports 16 to the ink circulation chambers 15 is supplied to the ink pressure chambers 14 through the communicating ports 17.

In the first embodiment, the ink supply ports 16 are located in the centers of the ink circulation chambers 15. Further, the communicating ports 17 are also located in the centers of the ink circulation chambers 15 and the centers of the ink pressure chambers 14. As a result, channel resistance applied when the ink is supplied from the plural ink circulation chambers 15 to the plural ink pressure chambers 14 is equalized. Fluctuation in an amount of the ink supplied to the ink pressure chambers 14 is suppressed.

The second substrate 13 is not limited to stainless steel and may be formed of other metal materials such as an aluminum alloy and titanium. In addition, a material forming the second substrate 13 is not limited to metal. For example, taking into account a difference between the expansion coefficients of the nozzle plate 2 and the first substrate 12, it is possible to use other materials as long as the materials do not affect ink ejection pressure.

Specifically, nitrides and oxides such as alumina, zirconium, silicon carbide, silicon nitride, and barium titanate serving as ceramic materials can be used. Further, plastic materials such as ABS (acrylonitrile-butadiene-styrene), polyacetal, polyamide, polycarbonate, and polyethersulfone can be used.

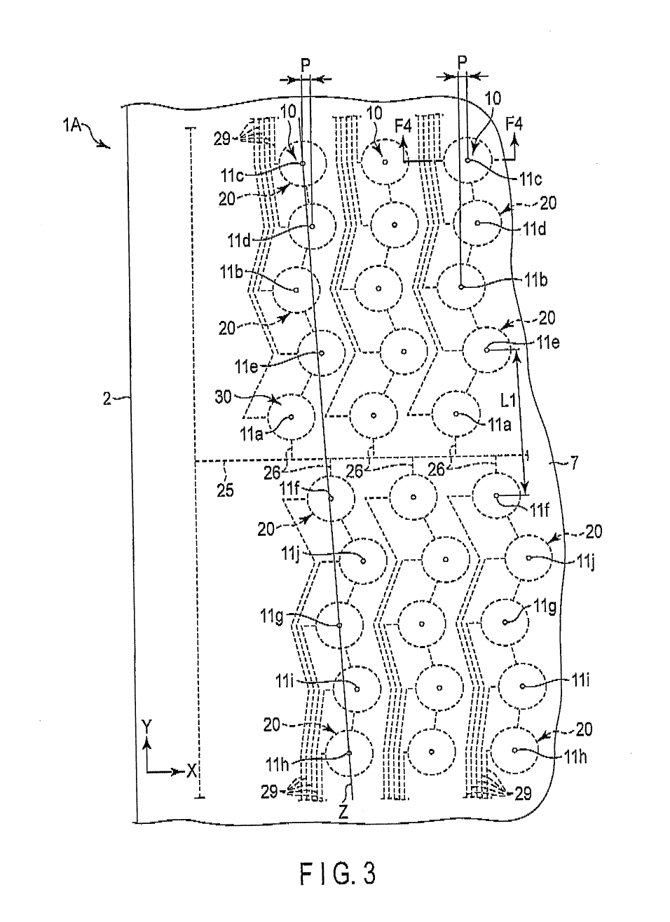

As shown in FIGS. 3 and 4, the nozzle plate 2 in the first embodiment incorporates plural actuators 20 that pressurize the ink. The actuators 20 are provided for the respective nozzles 11.

The actuators 20 are formed in a ring shape on the vibrating plate 4 to coaxially surround the nozzles 11. The actuators 20 are covered with the protective layer 5. Each of the actuators 20 includes a piezoelectric layer 21, a first electrode 22, and a second electrode 23.

The piezoelectric layer 21 is formed of, for example, PZT (lead zirconate titanate). As the material of the piezoelectric layer 21, PTO (PbTiO₃: lead titanate), PMNT (Pb(Mg_{1/3}Nb_{2/3})O₃—PbTiO₃), PZNT (Pb(Zn_{1/3}Nb_{2/3})O₃—PbTiO₃), ZnO, AlN, and the like can also be used.

The piezoelectric layer 21 is formed at substrate temperature of 350° C. by, for example, the RF magnetron sputtering method. The piezoelectric layer 21 has thickness of 3 μm and a diameter of 250 μm. In the first embodiment, after the piezoelectric layer 21 is formed, heat treatment is applied to the piezoelectric layer 21 at 500° C. for three hours in order to impart piezoelectricity to the piezoelectric layer 21. Consequently, the piezoelectric layer 21 can obtain satisfactory piezoelectric performance. When the piezoelectric layer 21 is formed, polarization along the thickness direction of the piezoelectric layer 21 occurs.

As other manufacturing methods for the piezoelectric layer 21, a CVD (chemical vapor deposition), a sol-gel method, an AD method (aerosol deposition method), a hydrothermal method, and the like can be used. In this case, the thickness of the piezoelectric layer 21 is in a range of about 0.1 μm to 10 μm.

The first electrode 22 and the second electrode 23 are components for transmitting a signal for driving the piezoelectric layer 21. The first electrode 22 and the second electrode 23 are formed of a thin film of, for example, Pt (platinum) and Ti (titanium). The thin film is formed by, for example, a sputtering method. The thickness of the thin film is 0.5 μm.

As other materials forming the first electrode 22 and the second electrode 23, Ni (nickel), Cu (copper), Al (aluminum), Ti (titanium), W (tungsten), Mo (molybdenum), and Au (gold) can be used. The various kinds of metal can be laminated.

As a method of forming the first electrode 22 and the second electrode 23, for example, vapor deposition and plating can also be used. In this case, desired thickness of the first electrode 22 and the second electrode 23 is 0.01 to 1 μm.

As shown in FIG. 4, the first electrodes 22 are formed on the vibrating plate 4. Each of the first electrodes 22 includes an electrode portion 24. The electrode portion 24 has a ring shape smaller in diameter than the piezoelectric layer 21. The electrode portion 24 is coaxially covered with the piezoelectric layer 21 and electrically connected to the piezoelectric layer 21. Further, the nozzle 11 coaxially pierces through the center of the electrode portion 24 and the center of the piezoelectric layer 21.

As shown in FIG. 3, the first electrodes 22 of the actuators 20 are electrically connected via plural relay wires 26 divided from a trunk wire 25. Therefore, the first electrodes 22 are connected to all the piezoelectric layers 21 in common. The first electrodes 22 act as common electrodes that apply a fixed voltage to all the piezoelectric layers 21. According to the first embodiment, the trunk wire 25 and the relay wires 26 are formed on the vibrating plate 4 and covered with the protective layer 5. The wiring width of the trunk wire 25 is about 100 μm.

As shown in FIG. 4, each of the second electrodes 23 includes an electrode portion 28 and wiring portions 29. The electrode portion 28 has a ring shape smaller in diameter than the piezoelectric layer 21. The electrode portion 28 is coaxially laminated on the piezoelectric layer 21 and electrically connected to the piezoelectric layer 21. Therefore, the piezoelectric layer 21 is held between the electrode portion 24 of the first electrode 22 and the electrode portion 28 of the second electrode 23. Further, the nozzle 11 pierces through the center of the electrode portion 28.

The wiring portions 29 of the second electrode 23 are drawn out from the outer circumferential edges of the electrode portions 28 to the outside of the actuators 20 along the vibrating plate 4 while being spaced apart from one another.

Therefore, the second electrodes 23 are individually connected to the piezoelectric layers 21. The second electrodes 23 act as individual electrodes that cause the respective piezoelectric layers 21 to independently operate. According to the first embodiment, the wiring portions 29 of the second electrode 23 form a predetermined conductor pattern. The wiring portions 29 are covered with the protective layer 5 together with the electrode portions 28. Since the wiring portions 29 are wired through the circumferences of the actuators 20, the wiring width of the wiring portions 29 is about 15 μm.

The trunk wire 25 electrically connected to the first electrodes 22 and the wiring portions 29 of the second electrodes 23 are led to the outside of the first inkjet head 1A and electrically connected to tape carrier packages. The tape carrier package is mounted with a driving circuit for driving the first inkjet head 1A.

The driving circuit supplies a driving voltage to the first electrode 22 and the second electrode 23 of each of the actuators 20. If an electric field in the same direction as the direction of the polarization of the piezoelectric layer 21 is applied from the first and second electrodes 22 and 23 to the piezoelectric layer 21, the actuator 20 is about to repeat expansion and contraction in a direction orthogonal to the direction of the electric field. The direction orthogonal to the direction of the electric field indicates a direction along the surface 4a of the vibrating plate 4.

Since the actuator 20 is formed on the vibrating plate 4, the vibrating plate 4 functions to prevent the expansion and contraction of the actuator 20. Therefore, stress is generated in a contact portion of the actuator 20 and the vibrating plate 4. The generated stress deforms the vibrating plate 4 to bend in the thickness direction.

As a result, the actuator 20 repeats the expansion and contraction in the direction orthogonal to the direction of the electric field, whereby the vibrating plate 4 exposed to the ink pressure chamber 14 vibrates in the thickness direction to increase the pressure of the ink in the ink pressure chamber 14. Therefore, a part of the ink pressurized in the ink pressure chamber 14 is ejected from the nozzles 11 to the sheet S as ink droplets.

FIG. 3 is a partially enlarged view of the nozzle rows 10 arrayed on the nozzle surface 7 of the nozzle plate 2. According to the first embodiment, the nozzle rows 10 extend in the conveying direction of the sheet S. The nozzle rows 10 are arranged in one hundred and twenty rows along the longitudinal direction of the nozzle plate 2 orthogonal to the conveying direction of the sheet S.

Each of the nozzle rows 10 includes first to tenth nozzles 11a, 11b, 11c, 11d, 11e, 11f, 11g, 11h, 11i, and 11j. The ten nozzles 11a to 11j included in the nozzle row 10 are arranged spaced apart from one another in the conveying direction of the sheet S in each of the nozzle rows 10.

Therefore, the nozzle plate 2 in the first embodiment includes one thousand and two hundred nozzles 11e to 11j. The one thousand and two hundred nozzles 11a to 11j form a nozzle group 30 two-dimensionally arrayed in a matrix shape at least over the length along the width direction of the sheet S.

As shown in FIG. 3, all the nozzles 11a to 11j opened in the nozzle surface 7 are arranged at a fixed pitch P in the longitudinal direction of the nozzle plate 2 in order to obtain desired resolution. The pitch P of the nozzles 11a to 11j is set to a value for preventing the ink pressure chambers 14 corresponding to the nozzles from interfering with the ink pressure chambers 14 corresponding to other nozzles adjacent to the nozzles 11e to 11j.

Further, the first to tenth nozzles 11a to 11j included in each of the nozzle rows 10 are arranged at random to be asymmetrical with respect to a straight line Z extending along the direction in which the nozzle row 10 extends.

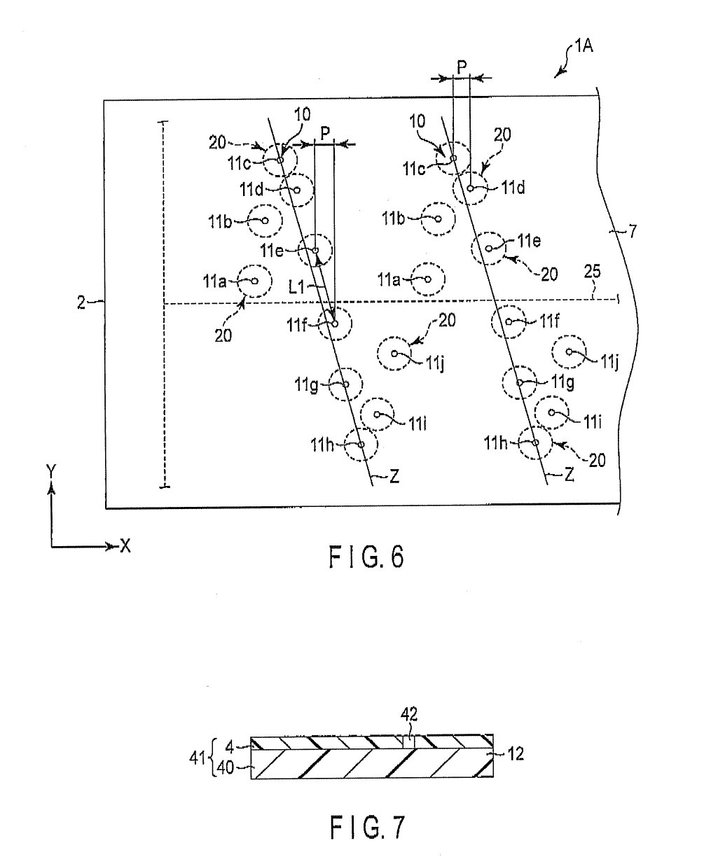

Specifically, in FIG. 6, the pitch P of the first to tenth nozzles 11a to 11j is shown in an exaggerated state. The first nozzle 11a is located at one end of the nozzle row 10. The tenth nozzle 11j is located at the other end of the nozzle row 10.

According to the first embodiment, in each of the nozzle rows 10, the first and second nozzles 11a and 11b located at one end portion of the nozzle row 10 are provided in positions shifted further to the upstream side along the conveying direction of the sheet S than the third nozzle 11c provided closest to the second nozzle 11b at the predetermined pitch P in the nozzle array direction.

In addition, in each of the nozzle rows 10, the ninth and tenth nozzles 11i and 11j located at the other end portion of the nozzle row 10 are provided in positions shifted further to the downstream side along the conveying direction of the sheet S than the eighth nozzle 11h provided closest to the ninth nozzle 11i at the predetermined pitch P in the nozzle array direction.

As a result, as most clearly shown in FIG. 6, the third to eighth nozzles 11c to 11h are arranged substantially in one row to extend along the straight line Z. The first and second nozzles 11a and 11b and the ninth and tenth nozzles 11i and 11j are off the straight line Z. Therefore, the first to tenth nozzles 11a to 11j are irregularly arrayed to be asymmetrical with respect to the straight line Z.

In the first embodiment, the trunk wire 25 is wired in the longitudinal direction of the nozzle plate 2 passing between the fifth nozzles 11e and the sixth nozzles 11f of the nozzle rows 10 arranged in one hundred and twenty rows. At the same time, between the nozzle rows 10 adjacent to each other, the trunk wire 25 passes between the tenth nozzle 11j of one nozzle row 10 and the first nozzle 11a of the other nozzle row 10.

Therefore, in each of the nozzle rows 10, in order to secure, between the fifth nozzle 11e and the sixth nozzle 11f, a space for allowing the trunk wire 25 to pass, an arrangement space L1 between the fifth nozzle 11e and the sixth nozzle 11f along the conveying direction of the sheet S is the largest in the nozzle row 10.

According to the first embodiment, for example, the diameter of the first to tenth nozzles 11a to 11j is set to 20 μm, the pitch P of the first to tenth nozzles 11a to 11j is set to 42 μm, the diameter of the ink pressure chambers 14 is set to 250 μm, and a space between the ink pressure chambers 14 incidental to nozzles provided closest to each other at the predetermined pitch P is set to 100 μm. If the nozzle rows 10 including the first to tenth nozzles 11a to 11j are arranged in one hundred and twenty rows in the X direction, the length of the nozzle plate 2 in the X direction is 52.5 mm and the length of the nozzle plate 2 in the Y direction is 5.25 mm. In this case, the arrangement space L1 between the fifth nozzle 11e and the sixth nozzle 11f along the conveying direction of the sheet S is 800 μm.

In the first embodiment, the pitch P is set on the assumption that six hundred nozzles are arranged per one inch in order to obtain desired resolution. The pitch P changes as appropriate according to a value of resolution. Therefore, naturally, the pitch P is not limited to 42 μm.

An example of a procedure for manufacturing the first inkjet head 1A including the configuration explained above is briefly explained with reference to FIGS. 7 to 21.

First, as shown in FIG. 7, a laminated body 41 is formed by laminating the vibrating plate 4 on a base 40, which is the base of the first substrate 12. Thereafter, for example, photolithography and dry etching are applied to the vibrating plate 4 to form an opening 42.

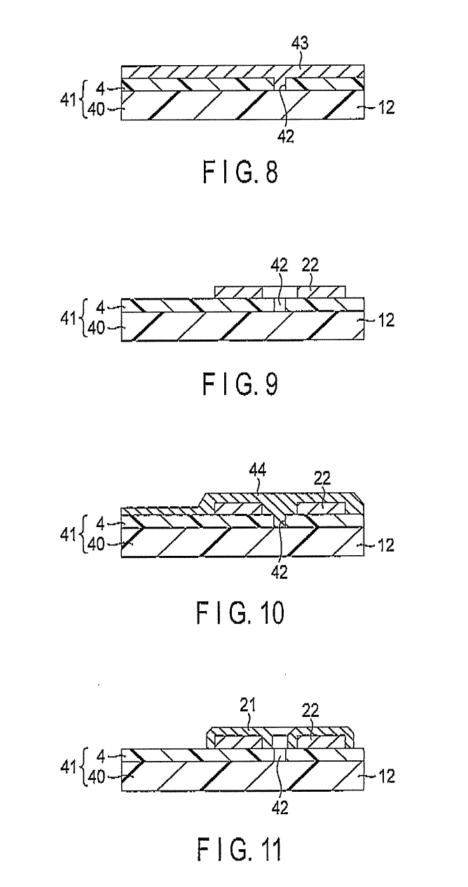

Subsequently, as shown in FIG. 8, a thin film 43 of platinum or titanium is formed on the vibrating plate 4 by, for example, the sputtering method.

Further, as shown in FIG. 9, for example, the photolithography and the dry etching are applied to the thin film 43 to form the ring-like first electrode 22 on the vibrating plate 4.

Thereafter, as shown in FIG. 10, a piezoelectric film 44 made of PZT is formed on the vibrating plate 4 and the first electrode 22 by, for example, the sputtering method. Subsequently, the photolithography and wet etching are applied to the piezoelectric film 44 to form the piezoelectric layer 21, which covers the first electrode 22, on the vibrating plate 4 (see FIG. 11).

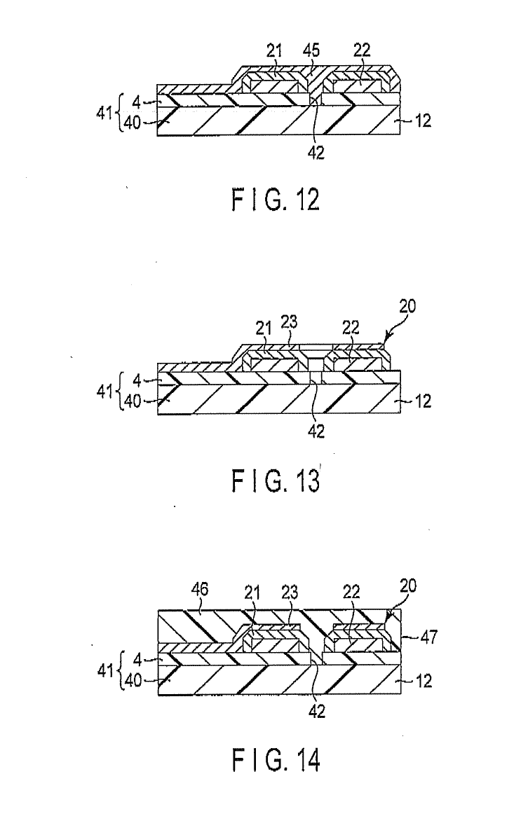

Thereafter, as shown in FIG. 12, a thin film 45 of platinum or titanium is formed on the vibrating plate 4 and the piezoelectric layer 21 by, for example, the CVD method or the sputtering method. Subsequently, for example, the photolithography and the dry etching are applied to the thin film 45 to form the ring-like second electrode 23 on the vibrating plate 4 and the piezoelectric layer 21. As a result, the actuator 20 is formed on the vibrating plate 4 (see FIG. 13).

Thereafter, as shown in FIG. 14, an electrode protecting film 46 is formed on the vibrating plate 4. Consequently, an intermediate molded product 47 in which the actuator 20 is covered with the electrode protecting film 46 is formed.

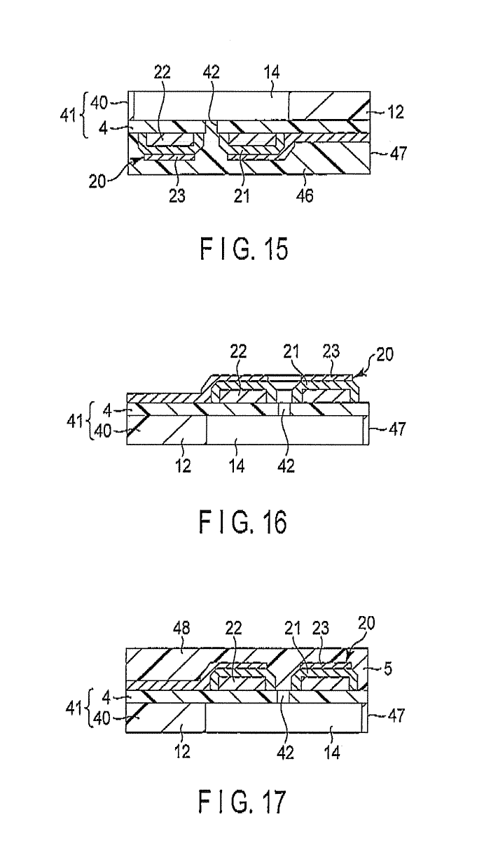

Thereafter, as shown in FIG. 15, the intermediate molded product 47 is vertically reversed and the base 40 is faced upward. In this state, for example, deep reactive ion etching is applied to the base 40 to form the ink pressure chamber 14 in the base 40.

Subsequently, as shown in FIG. 16, the intermediate molded product 47 is vertically reversed again and the electrode protecting film 46 is removed. Consequently, the vibrating plate 4 and the actuator 20 are exposed.

Thereafter, as shown in FIG. 17, a nozzle protecting film 48 to be the protective film 5 is formed on the vibrating plate 4 by, for example, the photolithography. The actuator 20 is covered with the nozzle protecting film 48. Further, the liquid repellent film 6 is laminated on the nozzle protecting film 48 by means such as the vapor deposition. As a result, the nozzle plate 2 incorporating the actuator 20 is formed.

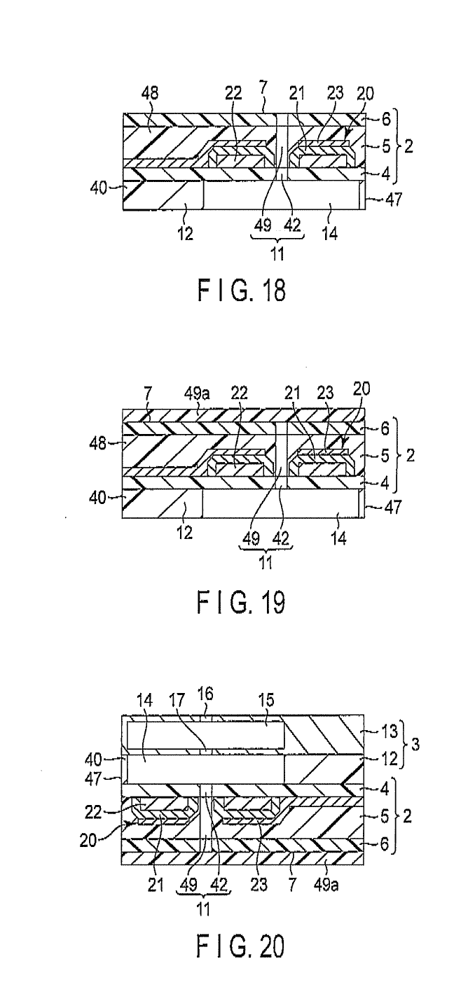

Thereafter, as shown in FIG. 18, for example, the dry etching and asking are applied to the nozzle protecting film 48 and the liquid repellent film 6 to form a through-hole 49 that pierces through the nozzle protecting film 48 and the liquid repellent film 6. The through-hole 49 coaxially communicates with the opening 42 of the vibrating plate 4 to form the nozzle 11.

Subsequently, as shown in FIG. 19, a nozzle protecting film 49a is laminated on the liquid repellent film 6 to protect the opening end of the nozzle 11 and the nozzle surface 7 with the nozzle protecting film 49a.

Thereafter, as shown in FIG. 20, the intermediate molded product 47 is vertically reversed again and the base 40, in which the ink pressure chamber 14 is formed, is faced upward. In this state, the second substrate 13, in which the ink circulation chamber 15, the ink supply port 16, and the communication port 17 are formed in advance, is bonded on the first substrate 12. Consequently, the head main body 3 in which the first substrate 12 and the second substrate 13 are integrated is formed.

Finally, the nozzle protecting film 49a is peeled off the liquid repellent film 6 to expose the nozzle surface 7. The intermediate molded product 47 is cut into a size determined in advance. Consequently, a series of process for forming the first inkjet head 1A is completed.

According to the first embodiment, in the nozzle rows 10 arrayed along the longitudinal direction of the nozzle plate 2, the first and second nozzles 11a and 11b located at one end portion of each of the nozzle rows 10 are provided further on the upstream side along the conveying direction of the sheet S than the third nozzle 11c provided closest to the second nozzle 11b in the nozzle array direction at the predetermined pitch P.

Further, the ninth and tenth nozzles 11i and 11j located at the other end portion of each of the nozzle rows 10 are provided further on the downstream side along the conveying direction of the sheet S than the eighth nozzle 11h provided closest to the ninth nozzle 11i in the nozzle array direction at the predetermined pitch P.

As a result, as shown in FIG. 6, the third to eighth nozzles 11c to 11h of the nozzle row 10 are arranged substantially in one row along the straight line Z. On the other hand, the first and second nozzles 11a and 11b and the ninth and tenth nozzles 11i and 11j are off the straight line Z.

The first to tenth nozzles 11a to 11j are arranged as explained above. Consequently, a distance between the fifth nozzle 11e and the sixth nozzle 11f, the arrangement space L1 between which along the conveying direction of the sheet S is the maximum, among the nozzles adjacent to one another in the X direction at the fixed pitch P can be suppressed to be not larger than 800 μm.

On the other hand, in FIG. 22, an inkjet head 1 as a comparative example is shown. In the inkjet head 1 in the comparative example, the first to tenth nozzles 11a to 11j included in the nozzle row 10 are linearly regularly arranged spaced apart from one another in an oblique direction having a fixed angle α with respect to the conveying direction of the sheet S.

In this comparative example, the pitch P of the first to tenth nozzles 11a to 11j along the X direction orthogonal to the conveying direction of the sheet S, the diameter of the nozzles 11a to 11j, the diameter of the ink pressure chambers 14, and the like are the same as those in the first embodiment.

As it is evident from FIG. 22, the tenth nozzle 11j located at the other end of one nozzle row 10 and the first nozzle 11a located at one end of another nozzle row 10 adjacent to the one nozzle row 10 are apart from each other in the conveying direction of the sheet S by a distance equivalent to the length of the nozzle rows 10.

In this comparative example, an arrangement space L2 along the Y direction between the tenth nozzle 11j located at the other end of one nozzle row 10 and the first nozzle 11e located at one end of the other nozzle row 10 adjacent to the one nozzle row 10 is 3500 μm.

According to such a comparative example, since the first to tenth nozzles 11a to 11j are linearly regularly arrayed, a place where the arrangement space L2 of the nozzles along the conveying direction of the sheet S locally widens is formed between the adjacent nozzle rows 10.

As a result, for example, if the sheet S is conveyed while tilting in the direction in which the nozzle rows 10 extend, the pitch P between the tenth nozzle 11j located at the other end of one nozzle row 10 and the first nozzle 11a located at one end of the other nozzle row 10 adjacent to the one nozzle row 10 is apparently expanded.

Therefore, for example, if the ink is ejected from the adjacent two nozzle rows 10 to the sheet S, it is inevitable that an interval of dots of the ink reaching the sheet S locally widens. Therefore, a white streak involved in absence of the ink sometimes occurs on an image formed on the sheet S.

On the other hand, with the first inkjet head 1A according to the first embodiment, the first to tenth nozzles 11a to 11j included in the nozzle row 10 are arrayed as explained above. Therefore, an arrangement space along the conveying direction of the sheet S among the first to tenth nozzles 11a to 11j adjacent to one another at the predetermined pitch P can be set as small as possible.

According to the first embodiment, although the trunk wire 25 passes between the fifth nozzle 11e and the sixth nozzle 11f, the arrangement space L1 between the fifth nozzle 11e and the sixth nozzle 11f largest in the nozzle row 10 is 800 μm. Therefore, compared with the comparative example, it is possible to substantially reduce the maximum arrangement space of the nozzles along the conveying direction of the sheet S.

As a result, even if the sheet S tilts in the direction in which the nozzle row 10 extends, it is possible to prevent an interval of dots of the ink reaching the sheet S from locally widening. Therefore, white streak-like printing unevenness less easily occurs on an image. It is possible to obtain a high-quality image having desired resolution.

In the first embodiment, the nozzle row including the ten nozzles is arranged in one hundred and twenty rows in the X direction orthogonal to the conveying direction of the sheet. However, the number of nozzle rows and the number of nozzles of one nozzle row are not limited to those in the first embodiment and can be changed as appropriate according to, for example, the resolution of an image required of an inkjet head.

### Second Embodiment

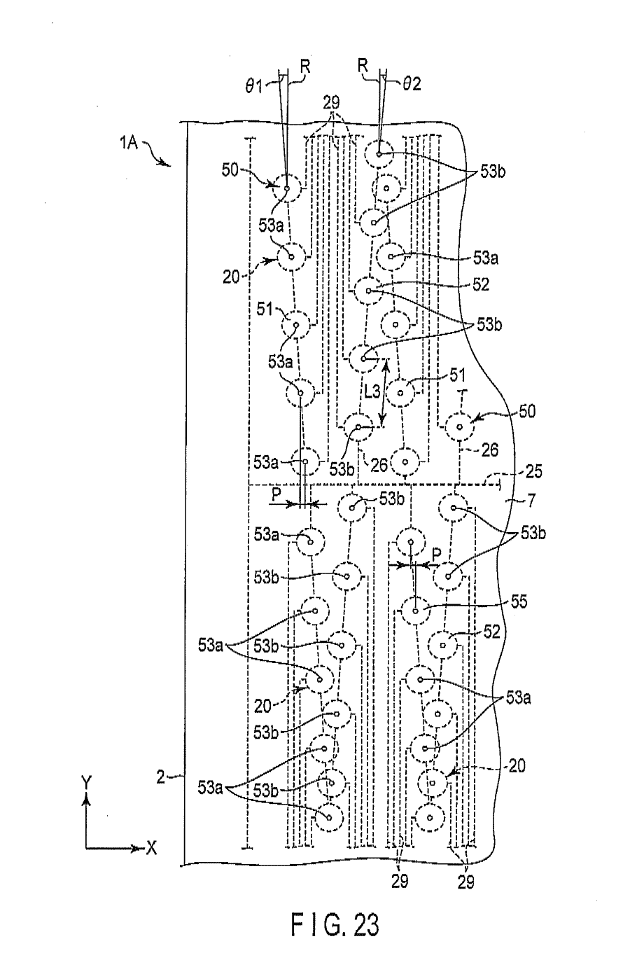

A second embodiment is shown in FIG. 23. The second embodiment is different from the first embodiment in the shape of a nozzle row along a conveying direction of a sheet. Otherwise, a basic configuration of the first inkjet head 1A is the same as that in the first embodiment. Therefore, in the second embodiment, components same as those in the first embodiment are denoted by the same reference numerals and signs and explanation of the components is omitted.

In FIG. 23, a state in which plural nozzle rows 50 are arrayed on the nozzle surface 7 of the nozzle plate 2 is shown. According to the second embodiment, the nozzle rows 50 extend in the conveying direction of the sheet S. The nozzle rows 50 are arranged in plural rows along the length direction of the nozzle plate 2 orthogonal to the conveying direction of the sheet S.

Each of the nozzle rows 50 includes a first row 51 and a second row 52. The first row 51 includes, for example, ten nozzles 53a. The second row 52 includes, for example, ten nozzles 55b. All the nozzles 53a and 53b are arranged at a predetermined pitch P in the length direction of the nozzle plate 2 in order to obtain desired resolution. The pitch P of the nozzles 53a and 53b are set to a value for preventing the ink pressure chambers 14 incidental to the nozzles 53a and 53b from interfering with the ink pressure chambers 14 of the nozzles 53a and 53b adjacent to the nozzles 53a and 53b at the predetermined pitch P.

The ten nozzles 53a included in the first row 51 is linearly arrayed spaced apart from one another in a direction inclined a predetermined angle θ1 with respect to a straight line R extending along the conveying direction of the sheet S. The ten nozzles 53b included in the second row 52 are linearly arrayed spaced apart from one another in a direction inclined a predetermined angle θ2 in the opposite direction of the first row 51 with respect to the straight line R.

In other words, the nozzles 53a of the first row 51 and the nozzles 53b of the second row 52 are arranged spaced apart from each other in the conveying direction of the sheet S.

As a result, the first and second rows 51 and 52 of each of the nozzle rows 50 are arranged in a V shape to be asymmetrical with respect to the straight line R extending along the conveying direction of the sheet S when the nozzle surface 7 is viewed two-dimensionally.

Therefore, in the first inkjet head 1A according to the second embodiment, the nozzles 53a and 53b of the plural nozzle rows 50 form a nozzle group 55 two-dimensionally arrayed in a matrix shape at least over the length along the width direction of the sheet S.

According to the second embodiment, for example, the diameter of the nozzles 53a and 53b is set to 20 μm, the pitch P of the nozzles 53a and 53b is set to 42 μm, the diameter of the ink pressure chambers 14 is set to 250 μm, and a space among the ink pressure chambers 14 incidental to the nozzles 53a and 53b provided closest to each other at the predetermined pitch P is set to 100 μm. If the nozzle row 50 in which the twenty nozzles 53a and 53b are arrayed in a V shape is arranged in one hundred and twenty rows in the X direction, the length in the X direction of the nozzle plate 2 is 52.5 mm and the length in the Y direction of the nozzle plate 2 is 7.2 mm.

Further, in this case, in the first row 51 and the second row 52 of the nozzle row 50, an arrangement space L3 between the nozzles 53a and 53b adjacent to each other in the conveying direction of the sheet S is 600 μm.

According to the second embodiment, each of the nozzle rows 50 includes the first and second rows 51 and 52 arranged in a V shape to be asymmetrical with respect to the straight line R extending along the conveying direction of the sheet S. Therefore, compared with the first embodiment, the dimension of the nozzle plate 2 along the conveying direction of the sheet S increases. However, concerning the nozzles 53a and 53b adjacent to each other at the predetermined pitch P, the arrangement space L3 of the nozzles 53a and 53b along the conveying direction of the sheet S can be set smaller than that in the first embodiment.

Therefore, even if the sheet S tilts with respect to the straight line R, it is possible to prevent an interval of dots of ink reaching the sheet S from locally widening. Therefore, white streak-like printing unevenness less easily occurs on an image. It is possible to obtain a high-quality image having desired resolution.

### Third Embodiment

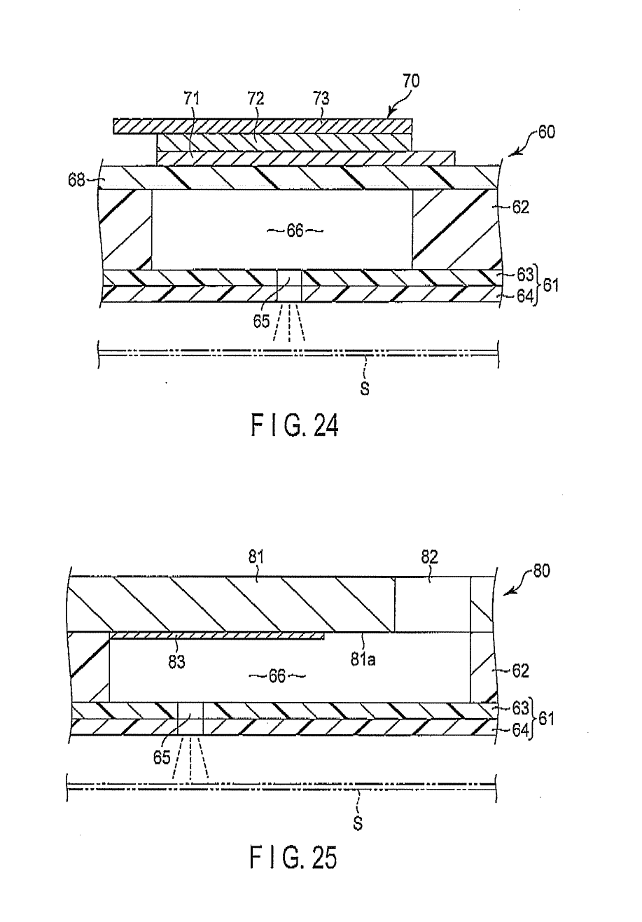

An inkjet head 60 according to a third embodiment is shown in FIG. 24. The inkjet head 60 according to the third embodiment is mainly different from the first embodiment in the configuration of a portion for pressurizing ink.

As shown in FIG. 24, the inkjet head 60 includes a nozzle plate 61 and a substrate 62. The nozzle plate 61 includes, for example, a single silicon substrate 63 and a liquid repellant film 64 that covers the surface of the silicon substrate 63. The nozzle plate 61 includes plural nozzles 65 (only one is shown in the figure). The nozzles 65 pierce through the nozzle plate 61 in the thickness direction. The nozzles 65 are arrayed in the nozzle plate 61, for example, in a pattern same as that in the first embodiment or the second embodiment.

The substrate 62 is formed of a single silicon substrate thicker than the nozzle plate 61. The substrate 62 is laminated on the nozzle plate 61 and integrated with the nozzle plate 61.

Ink pressure chambers 66 are formed in the substrate 62 in the same number as the nozzles 65. The ink pressure chambers 66 are formed in, for example, a cylindrical shape having a diameter larger than the nozzle 65. One ends of the nozzle pressure chambers 66 are closed by the nozzle plate 61. The nozzles 65 are provided to coaxially communicate with the centers of the ink pressure chambers 66. Further, the ink pressure chambers 66 are connected to a not-shown ink supply path. Therefore, ink for forming an image is supplied from the ink supply path to the ink pressure chambers 66.

A vibrating plate 68 is laminated on the substrate 62. The vibrating plate 68 is formed of, for example, a silicon oxide film having electric insulation properties. The vibrating plate 68 closes the other ends of the ink pressure chambers 66 to face the nozzle plate 61. Therefore, the vibrating plate 68 is exposed to the ink pressure chambers 66.

As shown in FIG. 24, an actuator 70 that pressurizes the ink is arranged on the vibrating plate 68. The actuator 70 is provided to correspond to each of the ink pressure chambers 66.

The actuator 70 includes a first electrode 71, a piezoelectric layer 72, and a second electrode 73. The first electrode 71 is formed on the upper surface of the vibrating plate 68. The piezoelectric layer 72 is made of, for example, PZT. The piezoelectric layer 72 is laminated on the first electrode 71 and electrically connected to the first electrode 71. The second electrode 73 is laminated on the piezoelectric layer 72 and electrically connected to the piezoelectric layer 72.

The first electrode 71 is connected to the piezoelectric layers 72 of all the actuators 70 in common. The first electrode 71 acts as a common electrode that applies a fixed voltage to all the piezoelectric layers 72. The second electrodes 73 are individually connected to the piezoelectric layers 72 of all the actuators 70. The second electrodes 73 act as individual electrodes that cause the respective piezoelectric layers 72 to independently operate.

If an electric field in the same direction as the direction of the polarization of the piezoelectric, layer 72 is applied from the first and second electrodes 71 and 72 to the piezoelectric layer 72, as in the first embodiment, the vibrating plate 68 vibrates in the thickness direction according to an expanding and contracting action of the actuator 70. Since the vibrating plate 68 is exposed to the ink pressure chamber 66, a pressure change occurs in the ink in the ink pressure chamber 66.

As a result, a part of the ink pressurized in the ink pressure chamber 66 is ejected from the nozzles 65 to the sheet S as ink droplets.

### Fourth Embodiment

An inkjet head 80 according to a fourth embodiment is shown in FIG. 25. The inkjet head 80 according to the fourth embodiment is different from the inkjet head 60 according to the third embodiment in a configuration for pressurizing ink in an ink pressure chamber. Otherwise, the configuration of the inkjet head 80 is the same as that in the third embodiment. Therefore, in the fourth embodiment, components same as those in the third embodiment are denoted by the same reference numerals and signs and explanation of the components is omitted.

As shown in FIG. 25, a top plate 81 is laminated on the substrate 62. The top plate 81 closes the other end of the ink pressure chamber 66 to face the nozzle plate 61. Further, the top plate 81 includes an ink supply port 82. The ink supply port 82 is connected to a not-shown ink supply path. Ink for forming an image is supplied from the ink supply path to the ink pressure chamber 66 through the ink supply port 82.

As shown in FIG. 25, the top plate 81 includes an inner surface 81a exposed to the ink pressure chamber 66. A heat generating element 83 such as a heater is attached to the inner surface 81a of the top plate 81. The heat generating element 83 is immersed in the ink filled in the ink pressure chamber 66.

In such a configuration, when the heat generating element 83 generates heat, the ink in the ink pressure chamber 66 is heated and air bubbles are formed. A pressure change is caused in the ink in the ink pressure chamber 66 by the air bubbles.

As a result, a part of the ink pressurized in the ink pressure chamber 66 is ejected from the nozzles 65 to the sheet S as ink droplets.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head comprising:
a nozzle plate; and
a plurality of nozzle rows provided on the nozzle plate to be arranged in a direction orthogonal to a conveying direction of a recording medium, each of the nozzle rows including a plurality of nozzles for ejecting ink to the recording medium, the nozzles being arranged at a fixed pitch along a direction orthogonal to the conveying direction of the recording medium and arranged spaced apart from one another in the conveying direction of the recording medium in each of the nozzle rows, at least one nozzle located at one end of each of the nozzle rows being provided further on an upstream side along the conveying direction of the recording medium than another nozzle provided closest to the nozzle in an arraying direction of the nozzles arranged at the fixed pitch, and at least one nozzle located at the other end of each of the nozzle rows being provided further on a downstream side along the conveying direction of the recording medium than another nozzle provided closest to the nozzle in the arraying direction of the nozzles arranged at the fixed pitch.

2. The inkjet head of claim 1, further comprising a plurality of actuators configured to pressurize the ink and eject the ink from the nozzles, the actuators being provided to correspond to the respective nozzles.

3. The inkjet head of claim 2, wherein the actuators are incorporated in the nozzle plate.

4. The inkjet head of claim 2, wherein the actuators are arranged spaced apart from one another.

5. The inkjet head of claim 1, wherein the plurality of nozzles included in each of the nozzle rows are arrayed to be asymmetrical with respect to a straight line along a direction in which the nozzle row extends.

6. The inkjet head of claim 1, wherein the nozzles form a nozzle group two-dimensionally arrayed at least over length corresponding to a width direction of the recording medium.

7. The inkjet head of claim 3, further comprising a head main body on which the nozzle plate is laminated, the head main body including a plurality of ink pressure chambers to which the ink is supplied, wherein
the nozzles respectively communicate with the ink pressure chambers.

8. The inkjet head of claim 7, wherein
the nozzle plate includes a vibrating plate exposed to the ink pressure chambers, and
when the actuators are driven, the vibrating plate is deformed to bend in a thickness direction to pressurize the ink supplied to the ink pressure chambers and eject the ink from the nozzles.

9. The inkjet head of claim 8, wherein the nozzles included in the nozzle row are arranged at a pitch for preventing the ink pressure chambers corresponding to the respective nozzles from interfering with one another.

10. An inkjet recording apparatus comprising:
a conveying path for conveying a recording medium; and
an inkjet head configured to eject ink to the recording medium to form an image on the recording medium,
the inkjet head including:
a nozzle plate; and
a plurality of nozzle rows provided on the nozzle plate to be arranged in a direction orthogonal to a conveying direction of the recording medium, each of the nozzle rows including a plurality of nozzles for ejecting ink to the recording medium, the nozzles being arranged at a fixed pitch along a direction orthogonal to the conveying direction of the recording medium and arranged spaced apart from one another in the conveying direction of the recording medium in each of the nozzle rows, at least one nozzle located at one end of each of the nozzle rows being provided further on an upstream side along the conveying direction of the recording medium than another nozzle provided closest to the nozzle in an arraying direction of the nozzles arranged at the fixed pitch, and at least one nozzle located at the other end of each of the nozzle rows being provided further on a downstream side along the conveying direction of the recording medium than another nozzle provided closest to the nozzle in the arraying direction of the nozzles arranged at the fixed pitch.
